(19) United States
(12) Patent Application Publication
(10) Pub. No.: US 2002/0174260 A1
(43) Pub. Date: Nov. 21, 2002

(54) Electronic mail transfer agent with a persistent queue, and related method of operation

(76) Inventor: Wei Huang, San Jose, CA (US)

Correspondence Address: COOLEY GODWARD, LLP, 3000 EL CAMINO REAL, 5 PALO ALTO SQUARE, PALO ALTO, CA, 94306, US

(21) Appl. No.: 09/860,686

(22) Filed: May 18, 2001

(51) Int. Cl. G06F 9/46

(52) U.S. Cl. 709/313

(57) ABSTRACT

A method of processing electronic mail messages includes configuring a queue on a permanent storage device. A set of electronic mail messages is accumulated to form a continuous electronic mail message block. The continuous electronic mail message block is stored in the queue in an uninterrupted write sequence.

### BRIEF DESCRIPTION OF THE INVENTION

This invention relates generally to the distribution of electronic mail in a networked environment. More particularly, this invention relates to a technique of utilizing a persistent queue in connection with an electronic mail transfer agent.

### BACKGROUND OF THE INVENTION

In a traditional postal system, a letter is sent to a first post office, which is responsible for sending the letter to another post office closer to the designated recipient. In an email system, the post office is called a Mail Transfer Agent (MTA). The protocol used between mail transfer agents is called the Simple Mail Transfer Protocol (SMTP).

FIG. 1 illustrates a prior art electronic mail system 20. A first user (e.g., User 1) sends an electronic mail message from an electronic device 22. The electronic mail message is processed by an MTA 24. The MTA 24 has an associated message store 26 to persistently store the message. The first user at electronic device 22 cannot receive an acknowledgment from the MTA 24 until the MTA 24 writes the message into the message store 26.

FIG. 1 also illustrates a set of mail delivery servers 28A and 28B. The mail delivery servers may be standard servers, such as Post Office Protocol (POP) or Internet Message Access Protocol (IMAP) servers. A second user (e.g., User 2) at an electronic device 30 accesses email messages through mail delivery server 28A, while a third user (e.g., User 3) at an electronic device 32 accesses email messages through mail delivery server 28B. Once an electronic mail message is successfully delivered to a mail delivery server, it can be deleted from the message store 26.

Thus, FIG. 1 illustrates how a message generated by a first user at electronic device 22 is processed by an MTA 24 to facilitate the delivery of the message to a second user at electronic device 30 and a third user at electronic device 32. As shown in FIG. 1, the MTA 24 processes other incoming messages and routes them to remote MTAs (not shown).

FIG. 2 illustrates a computer network 40 corresponding to the system shown in FIG. 1. In particular, FIG. 2 illustrates a first electronic device 22 connected to a server computer 42 through a network backbone 44, which may be any wired or wireless data transmission infrastructure. Also connected to the network backbone 44 is a second electronic device 30 and a third electronic device 32. As initially discussed in connection with the example of FIG. 1, the network 40 allows a first user at electronic device 22 to deliver a message to a second user at electronic device 30 and a third user at electronic device 32. By way of example, each electronic device 22, 30, and 32 includes a network connection circuit 50 for interfacing with the network backbone 44. The network connection circuit 50 is attached to a system bus 52. Also attached to the system bus 52 is a central processing unit 54. In addition, a memory 56 is connected to the system bus 52. The memory 56 stores a standard email application program 58.

The server 42 also includes a network connection circuit 60 and a central processing unit 62 connected via a system bus 64. A memory 66 stores a mail transfer agent module 68. The mail transfer agent module 68 includes a set of executable instructions to implement the functions of a mail transfer agent. The memory 66 also includes a message store 70 to store incoming electronic mail messages, as instructed by the mail transfer agent module 68.

FIG. 2 also illustrates a first mail deliver server 28A and a second mail delivery server 28B. Each mail delivery server includes a network connection circuit 80 connected to a central processing unit 82 via a system bus 84. A memory 86 is also connected to the system bus 84. The memory 86 stores a mail processing application 88, for example implementing a POP or IMAP server.

Thus, as in the example of FIG. 1, if an email message is generated at the first electronic device 22, it will be processed by the server 42, which includes a mail transfer agent module 68 and a message store 70. By way of example, the message may then be forwarded to server 28A and server 28B. After receiving acknowledgement from servers 28A and 28B, the copy of the message in the message store 70 may be deleted. The user at the second electronic device may then access the message from mail delivery server 28A, while the user at the third electronic device may access the message from mail delivery server 28B.

The various components discussed in connection with FIGS. 1 and 2 are well known in the art. Unfortunately, there are a number or problems associated with these prior art systems. One significant problem associated with these prior art systems is that there is a bottleneck on synchronous disk input/output as incoming messages are queued. In prior art systems, each message is written to disk as a separate file. Once a message is stored in this manner, an acknowledgement can be sent to the previous computer that stored the message, allowing the previous computer to delete the message from its message store and/or notify the user that the message has been sent.

A large-scale email deployment requires the ability to handle thousands of incoming messages per second. These messages result in small synchronous random disk accesses, which cause spindle contention and input/output bottleneck. Current email systems try to alleviate this problem through different approaches. One approach is to deploy more mail transfer agents. This approach is expensive in terms of capital, management expense, and physical space requirements. Another approach is to implement a temporary message store on a network file system incorporated in a multi-disk system so that spindle contention is amortized across many disks. Many small writes across a network files system are inefficient. Therefore, even though this method may relieve spindle contention, overall performance is not increased. Still another approach is to implement a temporary message store on a local Redundant Array of Individual Disks (i.e., a RAID unit) so that spindle contention is amortized across many disks. Although this approach improves performance, servicing the RAID units on a set of mail transfer agents is difficult. In addition, RAID units for every mail transfer agent are prohibitively expensive.

In view of the foregoing, it would be highly desirable to provide an improved technique for storing electronic mail messages in mail transfer agents. Such a technique could alleviate a substantial performance bottleneck that prevents current mail transfer agents from scaling to acceptably large sizes.

### SUMMARY OF THE INVENTION

The invention includes a method of processing electronic mail messages. A queue is configured on a permanent storage device or devices. A set of electronic mail messages or message portions are accumulated to form a continuous electronic mail message block. The continuous electronic mail message block is stored in the queue in an uninterrupted write sequence.

The invention also includes a computer readable memory to direct a computer to function in a specified manner. The computer readable memory includes a first set of instructions to configure a queue structure on a permanent storage device. A second set of instructions groups a set of sequentially received electronic mail messages into a continuous electronic mail message block. A third set of instructions produces a continuous disk write of the electronic mail message block to the queue structure.

The persistent queue of the invention provides fast input/output by aggregating small and scattered input/output events into one big, sequential input/output event. Sequential input/output can achieve raw disk input/output throughput, compared with small, scattered file system accesses, which can only obtain a small fraction of raw disk input/output throughput.

Another benefit associated with the invention is that it avoids fragmentation. After creating and deleting large numbers of files, the file system becomes fragmented. Fragmentation can slow down the overall system performance. The queue structure of the invention eliminates fragmentation because queues are re-cycled as a whole.

The checkpoint technique utilized in accordance with the persistent queue facilitates quick system recovery, allowing the mail transfer agent of the invention to operate in mission-critical applications. Advantageously, the invention can be implemented on relatively low cost hardware platforms, while still achieving high performance.

### BRIEF DESCRIPTION OF THE FIGURES

The invention is more fully appreciated in connection with the following detailed description taken in conjunction with the accompanying drawings, in which:

FIG. 1 is a general illustration of a prior art electronic mail system.

FIG. 2 illustrates a computer network implementing an electronic mail system.

FIG. 3 illustrates a computer configured in accordance with an embodiment of the invention.

FIG. 4 illustrates a persistent queue configured in accordance with an embodiment of the invention.

FIG. 5 illustrates a queue header data structure that may be utilized in accordance with an embodiment of the invention.

FIG. 6 illustrates a segment data structure that may be utilized in accordance with an embodiment of the invention.

FIG. 7 illustrates a queue recovery routine that may be utilized in accordance with an embodiment of the invention.

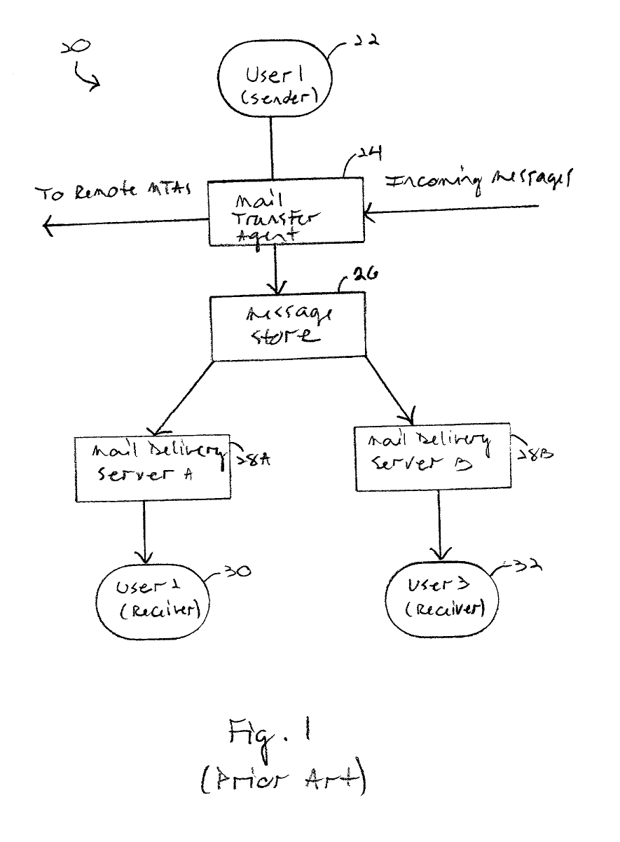

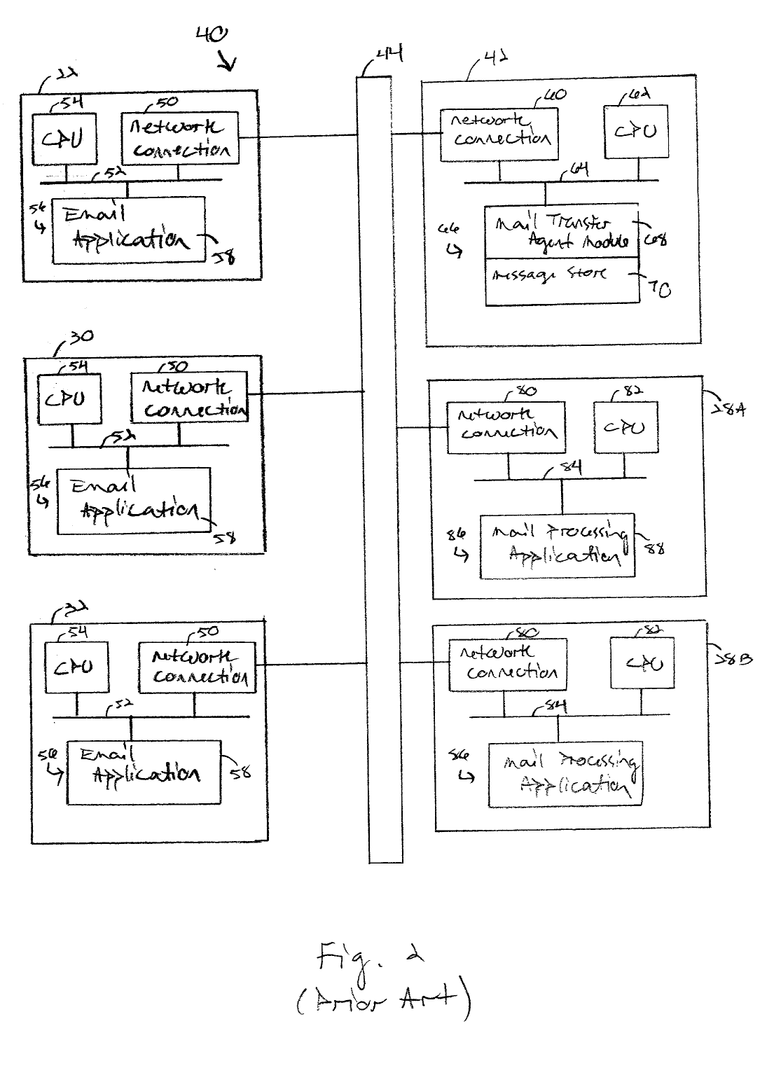

Like reference numerals refer to corresponding parts throughout the several views of the drawings.

### DETAILED DESCRIPTION OF THE INVENTION

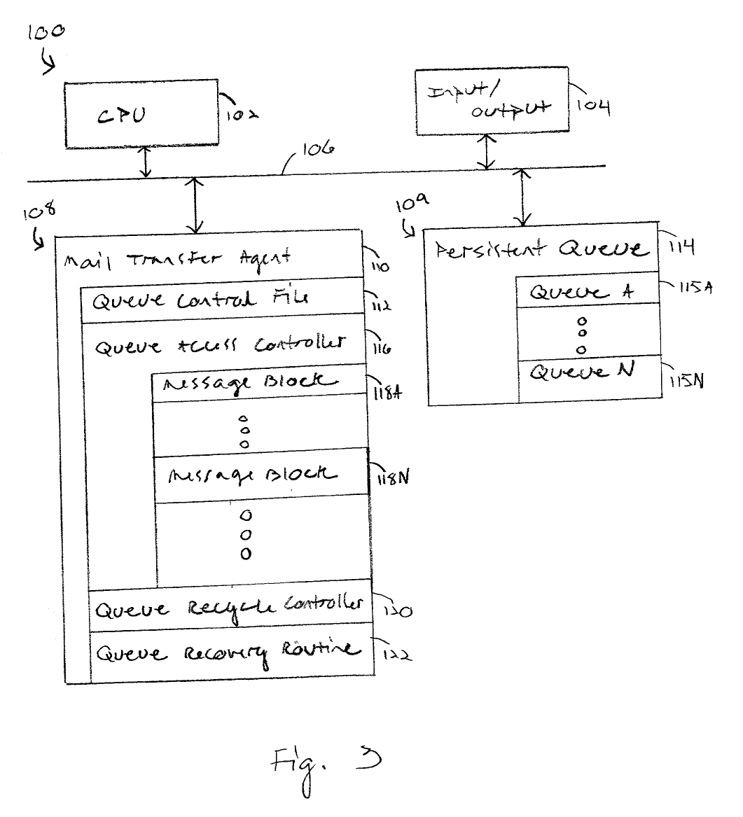

FIG. 3 illustrates an electronic system 100 implemented in accordance with an embodiment of the invention. The electronic system 100 includes a central processing unit 102 connected to a set of input/output devices 104 via a system bus 106. The input/output devices 104 may include a keyboard, mouse, video monitor, printer, network connection card, and the like. Also connected to the system bus are a primary memory 108 and a secondary memory 109. The primary memory 108 stores a mail transfer agent 110. The mail transfer agent 110 includes executable code to perform many of the functions performed by existing mail transfer agents. However, the mail transfer agent 110 also includes executable code to implement the operations of the present invention. In particular, the mail transfer agent 110 includes a queue control file 112. The queue control file may include executable code and settings used to form a persistent queue 114 in the secondary memory 109 of the electronic system 100.

When initially formed, the persistent queue 114 is a large empty file stored on one or more disks. The file can be a local file or a network file system file mounted on a storage server. As shown in FIG. 3, the persistent queue 114 may be implemented as a set of individual contiguous queues, such as queues 115A-115N. Each queue has a fixed size and location, which is reserved after the queue is created. Preferably, the queue control file 112 specifies the number of queues and the location and size of each queue. The persistent queue 114 may be formed across a set of disks. In addition, the persistent queue 114 may be mirrored or replicated across a set of disks.

The memory 108 also stores a queue access controller 116. The queue access controller 116 includes executable code that directs the mail transfer agent to accumulate a set of electronic mail messages to form a continuous electronic mail message block. Each message block 118A-118N is preferably stored in primary memory and is then stored in the persistent queue 114 in an uninterrupted write sequence. By accumulating individual electronic mail messages into large groups and then writing the individual messages as a single set of information, disk accesses are reduced and high-speed raw disk writes can be achieved. A message block may contain portions of a single large message.

The memory 108 further stores a queue recycle controller 120. The queue recycle controller 120 includes executable code to allow an individual queue (e.g., queue 115A) to be over written after every message stored in the queue has been successfully processed. By preserving the queue space on the disk drive until this over write operation occurs, the persistent queue reduces disk fragmentation, which results in enhanced disk access speeds.

The memory 108 also stores a queue recovery routine 122. The queue recovery routine 122 includes executable code to identify the checkpoint location corresponding to the last valid data segment stored in the persistent queue 114. After a fault, this information is used for subsequent data writes to the persistent queue 114, as discussed below.

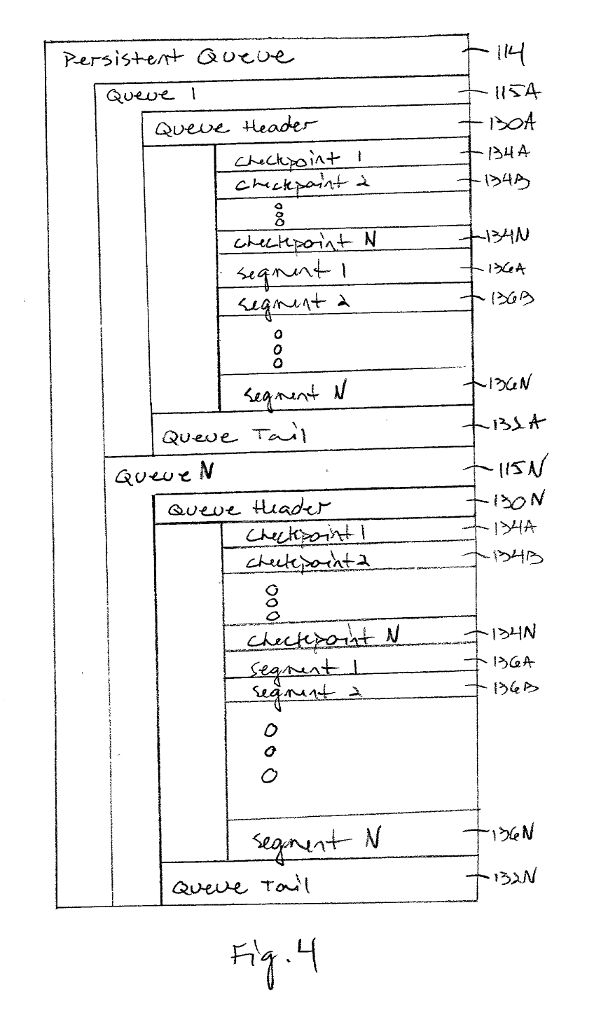

FIG. 4 is a more detailed illustration of a persistent queue 114 formed in accordance with an embodiment of the invention. The persistent queue 114 includes a set of individual contiguous queues 115A-115N. Each queue 115 includes a queue header 130 and a queue tail 132. Preferably, a set of checkpoints 134 are positioned between the queue header 130 and queue tail 132. The checkpoints 134 are used to track the writing of information into the queue so that in the event of a system failure, the queue can be reconstructed. The queue also includes data segments 136A-136N, which correspond to the electronic mail messages stored by the queue 114. In one embodiment of the invention, each data segment 136 corresponds to one message block 118 from the queue access controller 116.

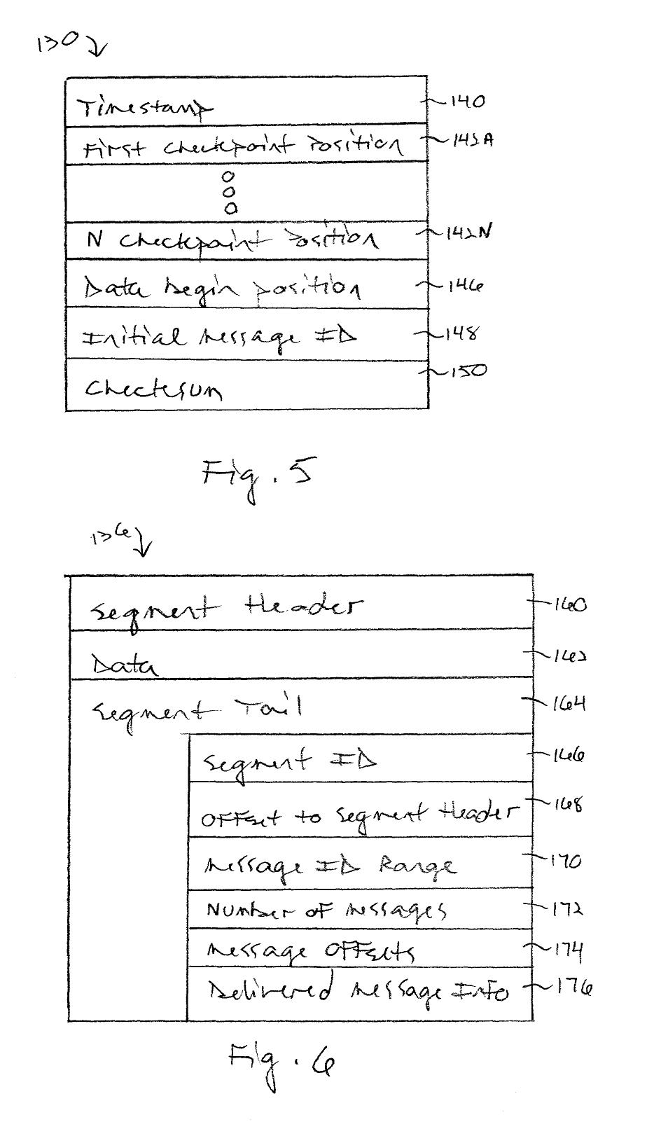

FIG. 5 illustrates a data structure that may be used to implement the queue header 130. In one embodiment of the invention, the queue header 130 includes a timestamp field 140, a first checkpoint position field 142A, a position field for the Nth checkpoint 142N, a data begin position field 146, an initial message identification field 148, and a checksum field 150. The timestamp field 140 stores the time that the queue is formed. The first checkpoint field 142A points to the position of the first checkpoint. Similarly, Nth checkpoint field 142N points to the position of the Nth checkpoint. The data begin position field 146 points to the beginning of the data area in the queue. A data area includes a set of segments, which are described below. The initial message identification field 148 stores the identification of the initial message in the queue. The checksum field is used for validation.

The queue tail 132 is the last element in each queue. Preferably, the queue tail 132 includes a timestamp and a checksum. The timestamp and checksum for the queue tail will match for a valid queue.

As previously indicated, the checkpoints 134 are used to reduce recovery time. Each checkpoint records the last segment begin position. In one embodiment, two checkpoints are used in each queue. If the system crashes during the writing of one checkpoint, the other checkpoint can be used in recovery. Additional checkpoints can be used to reduce recovery time. However, writing checkpoints causes extra synchronous input/output, which reduces system throughput. The queue control file 112 can be used to specify the duration of each checkpoint.

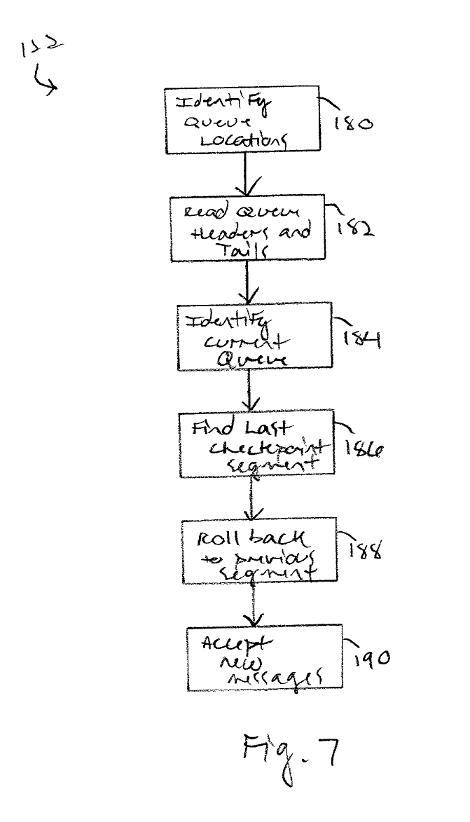

FIG. 6 illustrates a segment data structure that may be used in accordance with an embodiment of the invention. Data is stored in segments. Preferably, each write sequence to a disk causes one new segment to be created. If the current write sequence cannot fit into a single queue, the next queue is initialized and used. Preferably, each segment has three parts: a segment header 160, data 162, and a segment tail 164. The segment header 160 points to the position of the segment tail 164. The segment tail 164 preferably contains a segment identification field 166, an offset to the segment header 168, a message identification range 170, a message number 172, a message offset 174, and delivered message information 176. The delivered message information 176 specifies a low and high water mark. Every message below the low water mark has been delivered. Every message higher than the high water mark has not been delivered. A bitmap may be used to describe if the message in between has been delivered.

A large message may be fragmented into smaller pieces and then be written to the disk separately. The message fields 168-172 may be used to store information for this implementation.

Returning to FIG. 3, the memory 108 also stores a queue recovery routine 122. FIG. 7 illustrates processing steps that may be used to implement this operation. In the event of a system fault, the queue recovery routine 122 is invoked. The queue recovery routine 122 includes executable code to implement the following operations. First, the queue locations on disk are identified (180). This information may be obtained from the queue control file. The queue headers and queue tails are then read (182). The current queue is then identified using the queue header and/or queue tail timestamps (184). Once the current queue is identified, the checkpoint information in the queue is used to find the last checkpoint segment (186). The queue recovery routine 122 then rolls up to the previous segment in the queue (188). From this point forward, new messages may be accepted (190).

The mail transfer agent of the invention may be implemented in JAVA. Passing messages in a networked environment, manipulating strings, and processing database queries are strong implementation features associated with JAVA. A JAVA implementation also provides the benefits of extensibility, platform independence, and stability. Naturally, the invention may also be implemented using other programming languages. Alternately, the mail transfer agent of the invention may be implemented in a programmable logic device or as a hardwired circuit or as an application specific integrated circuit.

The persistent queue of the invention is general in nature. Therefore, its use can be extended to other implementations. For example, the techniques of the invention can be used to develop SMS or instant messaging applications on top of the message queue.

The foregoing description, for purposes of explanation, used specific nomenclature to provide a through understanding of the invention. However, it will be apparent to one skilled in the art that specific details are not required in order to practice the invention. Thus, the foregoing descriptions of specific embodiments of the invention are presented for purposes of illustration and description. They are not intended to be exhaustive or to limit the invention to the precise forms disclosed; obviously, many modifications and variations are possible in view of the above teachings. The embodiments were chosen and described in order to best explain the principles of the invention and its practical applications, the thereby enable other skilled in the art to best utilize the invention and various embodiments with various modifications as are suited to the particular use contemplated. It is intended that the scope of the invention be defined by the following claims and their equivalents.

In the claims:

1. A method of processing electronic mail messages, comprising:
configuring a queue on a permanent storage device;
accumulating a set of electronic mail messages to form a continuous electronic mail message block; and
storing said continuous electronic mail message block in said queue in an uninterrupted write sequence.

2. The method of claim 1 wherein configuring includes configuring said queue as a set of individual contiguous queues on said permanent storage device.

3. The method of claim 2 further comprising deleting a selected electronic mail message from said queue after said selected electronic mail message is successfully forwarded.

4. The method of claim 3 further comprising designating a selected queue of said set of individual contiguous queues for an overwrite operation when each electronic mail message in said selected queue has been successfully forwarded.

5. The method of claim 1 wherein configuring includes configuring said queue in accordance with a set of instructions specified in a queue control file.

6. The method of claim 1 wherein configuring includes configuring said queue to include a queue header and a queue tail.

7. The method of claim 6 wherein configuring includes configuring said queue to include a queue header specifying a time stamp field, a check point position field, a data segment begin position field, and a check sum field.

8. The method of claim 6 wherein configuring includes configuring said queue to include a set of checkpoints and data segments between said queue header and said queue tail.

9. The method of claim 8 wherein configuring includes configuring said queue to include data segments specifying a segment header field, a data field, and a segment tail field.

10. The method of claim 8 further comprising recovering from a fault by identifying a selected checkpoint location associated with the last valid data entry prior to said fault.

11. A computer readable memory to direct a computer to function in a specified manner, comprising:
a first set of instructions to configure a queue structure on a permanent storage device;
a second set of instructions to group a set of sequentially received electronic mail messages into a continuous electronic mail message block; and
a third set of instructions to produce a raw disk write of said continuous electronic mail message block to said queue structure.

12. The computer readable memory of claim 11 wherein said first set of instructions configures said queue as a set of individual contiguous queues on said permanent storage device.

13. The computer readable memory of claim 12 further comprising instructions to delete a selected electronic mail message from said queue after said selected electronic mail message is successfully forwarded.

14. The computer readable memory of claim 13 further comprising instructions to designate a selected queue of said set of individual contiguous queues for an overwrite operation when each electronic mail message in said selected queue has been successfully forwarded.

15. The computer readable memory of claim 11 wherein said first set of instructions includes instructions to configure said queue with a queue header and a queue tail.

16. The computer readable memory of claim 15 wherein said queue header includes a time stamp field, a check point position field, a data segment begin position field, and a check sum field.

17. The computer readable memory of claim 15 wherein said first set of instructions includes instructions to configure said queue with a set of checkpoints and data segments between said queue header and said queue tail.

18. The computer readable memory of claim 17 further comprising instructions to recover from a fault by identifying a selected checkpoint location associated with the last valid data entry prior to said fault.
